(19) United States
(12) Patent Application Publication
(10) Pub. No.: US 2020/0219019 A1
(43) Pub. Date: Jul. 9, 2020

(54) ARTIFICIAL INTELLIGENCE DEVICE AND OPERATING METHOD THEREOF

(71) Applicant: LG ELECTRONICS INC., Seoul (KR)

(72) Inventors: Junghwa CHOI, Seoul (KR); Yeonjung KIM, Seoul (KR)

(73) Assignee: LG ELECTRONICS INC., Seoul (KR)

(21) Appl. No.: 16/735,503

(22) Filed: Jan. 6, 2020

Related U.S. Application Data
(60) Provisional application No. 62/788,962, filed on Jan. 7, 2019.

(51) Int. Cl. G06Q 10/02; G06N 20/00; G06N 7/00; G06Q 10/06; B60L 53/68; B60L 53/30

(52) U.S. Cl. CPC G06Q 10/02; G06N 20/00; B60L 53/305; G06Q 10/06312; B60L 53/68; G06N 7/005

(57) ABSTRACT

An AI device according to an embodiment of the present disclosure receives reservation input information for reserving charging of an electric car, and displays a charger available time table indicating an available time or an unavailable time of each of a plurality of chargers based on the received reservation input information and a charging reservation scheduling model, and the charger available time table is a table in which one or more time slots match each of the plurality of chargers.

### CROSS-REFERENCE TO RELATED APPLICATIONS

Pursuant to 35 U.S.C. § 119(e), this application claims the benefit of U.S. Provisional Patent Application No. 62/788,962, filed on Jan. 7, 2019, the contents of which are all hereby incorporated by reference herein in its entirety.

### FIELD

The present disclosure relates to an artificial intelligence (AI) device, and more particularly, to charging reservation scheduling of an electric car.

### BACKGROUND

Driving energy for moving cars is generally obtained by burning fossil fuels. Compared to this, electric cars use electric energy as driving energy.

Electric cars have the advantages that exhaust gas is not generated and a noise is reduced since fossil fuels do not burn.

Such an electric car should be provided with a battery to provide electric energy therein since the electric car is driven by using electric energy. As electric cars are developing in recent years, chargers are provided at specific locations to charge a battery of an electric car.

A charger guide system which has been developed up to now provides a user of an electric car with location information of a charger, such that the user of the electric car can find a closer charger and can charge the car.

However, according to related-art technology, the user identifies the location of the charger by using the location information of the charger, but, if another car is being charged when the user arrives at the charger to charge the electric car, the user should wait until charging of another car is completed.

In particular, since it takes a long time for a normal electric car to be fully charged from a discharged state, the user has no choice but to wait if another car is being charged.

In addition, even if the user is provided with information regarding whether a charger is used, the user may not know when the charger is available, and thus the user should wait until availability information of the corresponding charger is identified.

### SUMMARY

An object of the present disclosure is to provide scheduling a charging reservation of an electric car by considering user's convenience.

Another object of the present disclosure is to provide minimizing an idle time of a charger and increasing a charging occupancy time.

An AI device according to an embodiment of the present disclosure may receive reservation input information for reserving charging of an electric car, and may display a charger available time table indicating an available time or an unavailable time of each of a plurality of chargers based on the received reservation input information and a charging reservation scheduling model, and the charger available time table is a table in which one or more time slots match each of the plurality of chargers.

Each time slot included in the charger available time table may indicate a source of a charger and information on whether charging is possible at a charging time inputted by a user.

The processor may determine a source of each time slot and determine whether charging is possible at each time slot, by using information regarding the charger, and may generate the charger available time table according to a result of the determination.

According to an embodiment of the present disclosure, a user can schedule a charging reservation of an electric car simply by a user input. Accordingly, a user's charging reservation process can be simplified and convenience can be greatly enhanced.

In addition, idle times of charging points provided in each oil station can be minimized and using efficiency of the charging points can be maximized.

### BRIEF DESCRIPTION OF THE DRAWINGS

The present disclosure will become more fully understood from the detailed description given herein below and the accompanying drawings, which are given by illustration only, and thus are not limitative of the present disclosure, and wherein:

FIG. 1 illustrates an AI device according to an embodiment of the present disclosure;

FIG. 2 illustrates an AI server according to an embodiment of the present disclosure;

FIG. 3 illustrates an AI system according to an embodiment of the present disclosure;

FIG. 4 illustrates an AI device according to another embodiment of the present disclosure;

FIG. 5 is a view defining possible relations between time intervals according to related-art technology;

FIGS. 6 to 7D are views illustrating a process of scheduling charging reservations of electric cars with respect to six (6) time interval relations by using three (3) charging points;

FIGS. 8 to 9D are views illustrating a process of scheduling charging reservations with respect to thirteen (13) time interval relations through ten (10) charging points according to an embodiment of the present disclosure;

FIG. 10 is a view illustrating charging available time slots regarding thirteen (13) time interval relations according to an embodiment of the present disclosure;

FIG. 11 is a view illustrating a process of setting a charging schedule by allocating the fourteen (14) time slots of FIG. 10 through ten (10) charging points according to an embodiment of the present disclosure;

FIG. 12 is a view illustrating a summary of the result of allocating the fourteen (14) time slots to charging points if there are ten (10) charging points;

FIG. 13 is a flowchart illustrating an operating method of an AI device according to an embodiment of the present disclosure;

FIG. 14 is a view illustrating an example of a charging reservation input screen according to an embodiment of the present disclosure;

FIG. 15 is a view illustrating a charging reservation screen to provide charging reservation information according to an embodiment of the present disclosure; and

FIG. 16 is a view illustrating a result of charging reservation of an electric car according to an embodiment of the present disclosure.

### DETAILED DESCRIPTION

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network may be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer if the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving device may include an actuator or a motor and may perform various physical operations such as moving a robot joint. In addition, a movable robot may include a wheel, a brake, a propeller, and the like in a driving device, and may travel on the ground through the driving device or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined path, and a technology for automatically setting and traveling a path if a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

In this case, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are illustrated together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

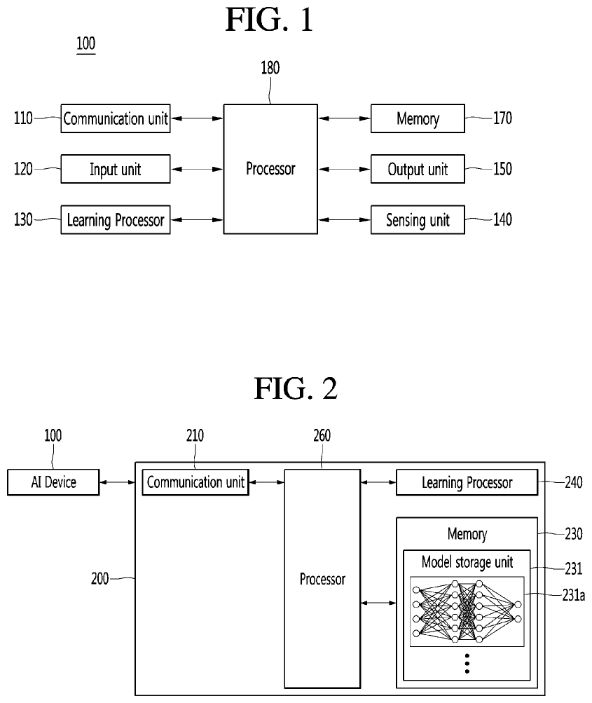

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing device 140, an output device 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

In this case, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used if an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

In this case, the learning processor 130 may perform AI processing together with the learning processor 240 of the AI server 200.

In this case, the learning processor 130 may include a memory integrated or implemented in the AI device 100. Alternatively, the learning processor 130 may be implemented by using the memory 170, an external memory directly connected to the AI device 100, or a memory held in an external device.

The sensing device 140 may acquire at least one of internal information about the AI device 100, ambient environment information about the AI device 100, and user information by using various sensors.

Examples of the sensors included in the sensing device 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output device 150 may generate an output related to a visual sense, an auditory sense, or a haptic sense.

In this case, the output device 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

If the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. In this case, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 may transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models is implemented in software, one or more instructions that constitute the learning model may be stored in memory 230.

The processor 260 may infer the result value for new input data by using the learning model and may generate a response or a control command based on the inferred result value.

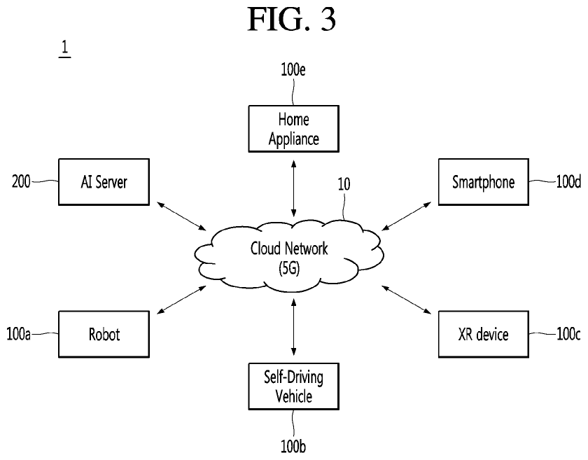

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

In other words, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1. In other words, the robot 100a, the self-driving vehicle 100b, the XR device 100c, the smartphone 100d, or the home appliance 100e through the cloud network 10, and may assist at least part of AI processing of the connected AI devices 100a to 100e.

In this case, the AI server 200 may learn the artificial neural network according to the machine learning algorithm instead of the AI devices 100a to 100e, and may directly store the learning model or transmit the learning model to the AI devices 100a to 100e.

In this case, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the path and the travel plan, may determine the response to user interaction, or may determine the operation.

The robot 100a may use the sensor information acquired from at least one sensor among the lidar, the radar, and the camera so as to determine the travel path and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

In this case, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel path and the travel plan, and may control the driving device such that the robot 100a travels along the determined travel path and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving device based on the control/interaction of the user. In this case, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the path and the travel plan, or may determine the operation.

Like the robot 100a, the self-driving vehicle 100b may use the sensor information acquired from at least one sensor among the lidar, the radar, and the camera so as to determine the travel path and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

In this case, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel path and the travel plan, and may control the driving device such that the self-driving vehicle 100b travels along the determined travel path and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving device based on the control/interaction of the user. In this case, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

In this case, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel path or the travel plan. For example, the robot 100a and the self-driving vehicle 100b having the self-driving function may determine at least one of the travel path or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

In this case, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, if it is determined that the driver is in a drowsy state, the robot 100a may activate the self-driving function of the self-driving vehicle 100b or assist the control of the driving device of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot. In other words, subjected to control/interaction in an XR image. In this case, the robot 100a may be separated from the XR device 100c and interwork with each other.

If the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user may confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving vehicle 100b, to which the XR technology is applied, may refer to a self-driving vehicle having a means for providing an XR image or a self-driving vehicle. In other words subjected to control/interaction in an XR image. Particularly, the self-driving vehicle 100b. In other words, subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

In this case, if the XR object is output to the HUD, at least part of the XR object may be outputted so as to overlap the actual object to which the passenger's gaze is directed. Meanwhile, if the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

If the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

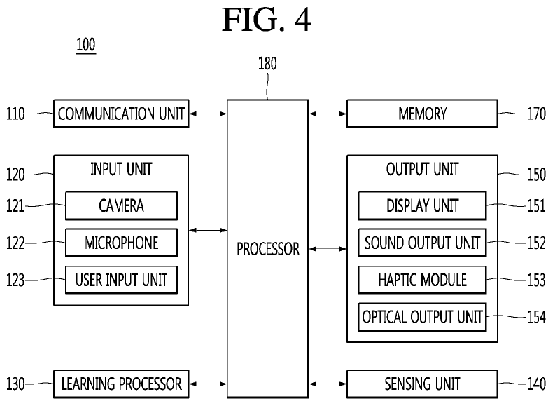

FIG. 4 illustrates an AI device 100 according to an embodiment of the present disclosure.

The redundant repeat of FIG. 1 will be omitted below.

Referring to FIG. 4, the input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information inputted from a user and the mobile terminal 100 may include at least one camera 121 in order for inputting image information.

The camera 121 processes image frames such as a still image or a video acquired by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the mobile terminal 100. Moreover, various noise canceling algorithms for removing noise occurring during the reception of external sound signals may be implemented in the microphone 122.

The user input unit 123 is to receive information from a user and if information is inputted through the user input unit 123, the processor 180 may control an operation of the mobile terminal 100 to correspond to the inputted information.

The user input unit 123 may include a mechanical input means (or a mechanical key, for example, a button, a dome switch, a jog wheel, and a jog switch at the front, back or side of the mobile terminal 100) and a touch type input means. As one example, a touch type input means may include a virtual key, a soft key, or a visual key, which is displayed on a touch screen through software processing or may include a touch key disposed at a portion other than the touch screen.

The output device 150 may include at least one of a display unit 151, a sound output module 152, a haptic module 153, or an optical output module 154.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the mobile terminal 100 and a user, and an output interface between the mobile terminal 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user may feel. A representative example of a haptic effect that the haptic module 153 generates is vibration.

The optical output module 154 outputs a signal for notifying event occurrence by using light of a light source of the AI device 100. An example of an event occurring in the AI device 100 includes message reception, call signal reception, missed calls, alarm, schedule notification, e-mail reception, and information reception through an application.

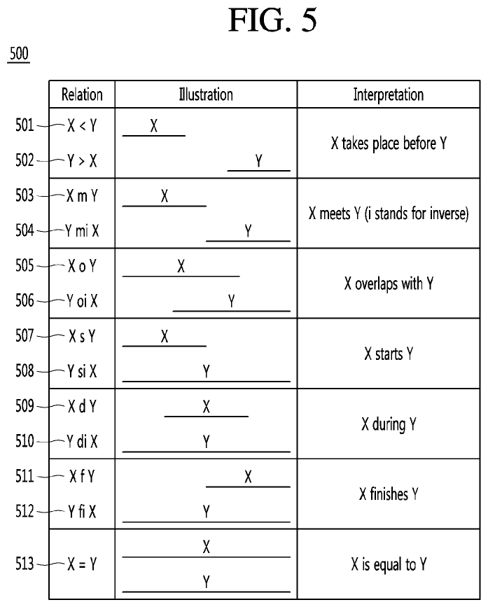

FIG. 5 is a view defining possible relations between time intervals according to related-art technology.

Referring to FIG. 5, a table 500 explaining a time relation theory indicating that situations including time are defined by thirteen (13) relations is illustrated.

The table 500 is based on the time interval algebra suggested by Allen, and indicates that time relations of all situations are expressed by thirteen (13) interval relations.

Each of the thirteen (13) relations indicates a possible relation between two time intervals.

A 1^{st} relation 501 and a 2^{nd} relation 502 indicate a situation in which X takes place before Y.

For example, if X indicates a time interval between 10 a.m. and 10:30 a.m., Y may indicate a time interval between 10:45 a.m. and 11 a.m.

If this is applied to charging reservation scheduling of an electric car, X indicates a situation in which a first electric car is scheduled to be charged from 10 a.m. to 10:30 a.m. on Dec. 25, 2018, and Y indicates a situation in which a second electric car is scheduled to be charged from 10:45 a.m. to 11 a.m. on Dec. 25, 2018.

A 3^{rd} relation 503 and a 4^{th} relation 504 indicate a situation in which X meets Y. That is, the 3^{rd} relation 503 and the 4^{th} relation 504 indicate a situation in which Y takes place right after X.

A 5^{th} relation 505 and a 6^{th} relation 506 indicate a situation in which X and Y overlap each other.

A 7^{th} relation 507 and an 8^{th} relation 508 indicate a situation in which X starts Y. That is, the 7^{th} relation 507 and the 8^{th} relation 508 indicate a situation in which X and Y take place simultaneously and Y continues after X finishes.

A 9^{th} relation 509 and a 10^{th} relation 510 indicate a situation in which X takes place during Y.

An 11^{th} relation 511 and a 12^{th} relation 512 indicate a situation in which X finishes Y. That is, the 11^{th} relation 511 and the 12^{th} relation 512 indicate a situation in which Y takes place first, and then, X takes place, and X and Y finish simultaneously.

A 13^{th} relation 513 indicates a situation in which X and Y are equal to each other.

The 1^{st} to 13^{th} relations 501 to 513 may be applied to charging reservation scheduling of an electric car.

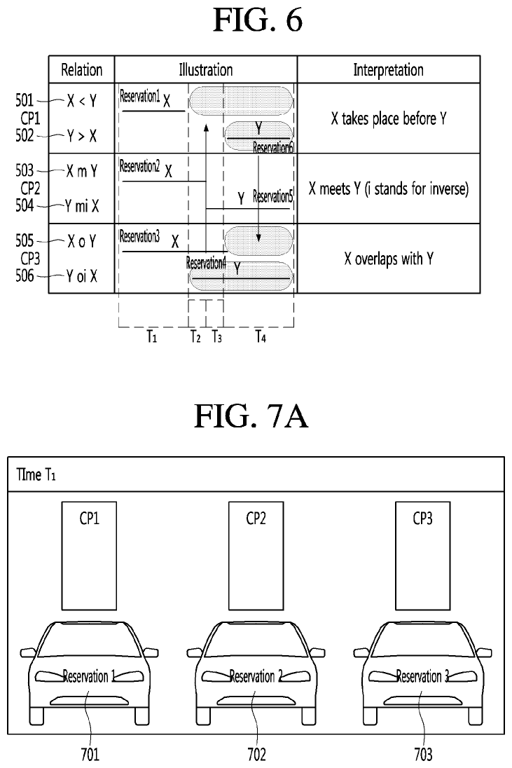

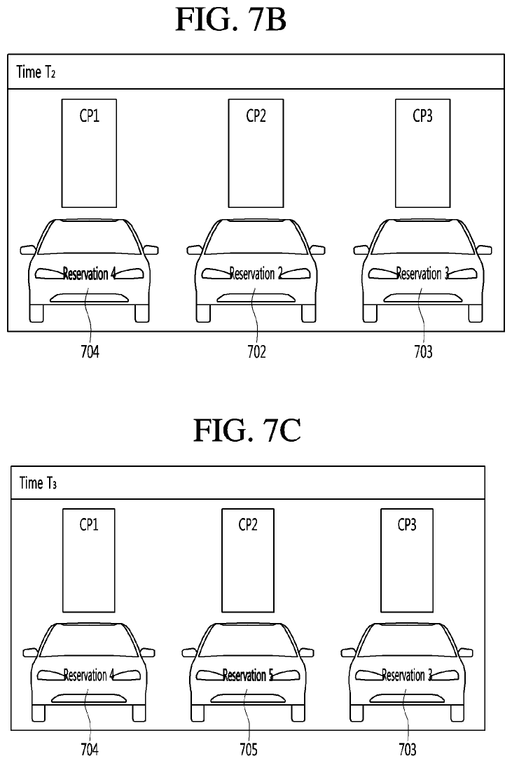

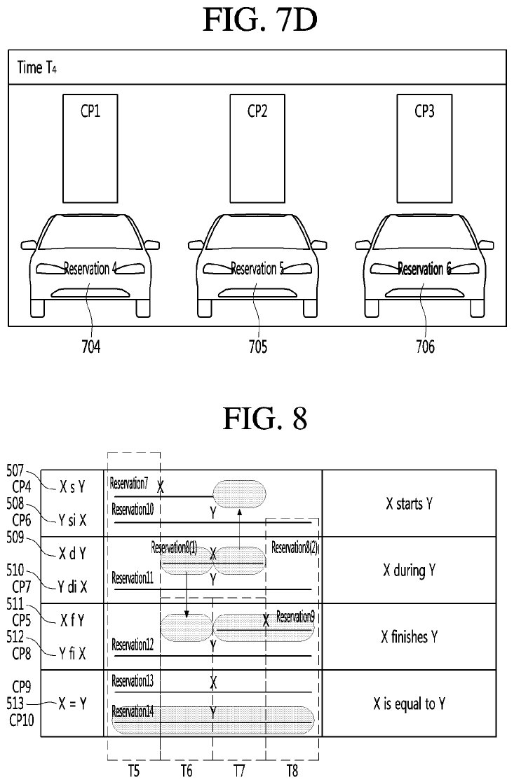

FIGS. 6 to 7D are views illustrating a process of scheduling charging reservations of electric cars with respect to six (6) time interval relations by using three (3) charging points according to an embodiment of the present disclosure.

The charging point (CP) may be a charging device which can charge an electric car.

Referring to FIG. 6, it is assumed that the 1^{st} relation 501 and the 2^{nd} relation 502 are allocated to a 1^{st} charging point CP1, the 3^{rd} relation 503 and the 4^{th} relation 504 are allocated to a 2^{nd} charging point CP2, and the 5^{th} relation 505 and the 6^{th} relation 506 are allocated to a 3^{rd} charging point CP3.

The 1^{st} to 6^{th} relations 501 to 506 may be divided into four (4) time periods T1, T2, T3, T4 in total.

According to the Allen's time interval algebra, during T2 and T3 of the four (4) time periods T1, T2, T3, T4, the 1st charging point CP1 does not charge an electric car. That is, an idle time is given to the 1^{st} charging point CP1 during T2 and T3.

To the contrary, during T2 and T3, the 3^{rd} charging point CP3 may not charge two electric cars overlappingly according to the 5^{th} relation 505 and the 6^{th} relation 506.

Accordingly, during T2 and T3, a charging reservation may be allocated by using the 1^{st} charging point CP1 which is idle.

This will be described in detail.

Referring to FIGS. 7A to 7D, the processor 180 of the AI device 100 may schedule such that the 1^{st} charging point CP1 charges a 1^{st} electric car 701 during T1. The schedule to make the 1^{st} charging point CP1 charge the 1^{st} electric car 701 during T1 is referred to as a reservation 1.

A schedule to make the 2^{nd} charging point CP2 charge a 2^{nd} electric car 702 during T1 and T2 is referred to as a reservation 2.

A schedule to make the 3^{rd} charging point CP3 charge a 3^{rd} electric car 703 during T1 to T3 is referred to as a reservation 3.

During T2 and T3, the 1^{st} charging point CP1 may be scheduled to charge a 4^{th} electric car 704. This schedule is referred to as a reservation 4.

That is, the 1^{st} charging point CP1 may be allocated the reservation 4 during T2 and T3 after T1.

During T3 and T4, the 2^{nd} charging point CP2 may be allocated a reservation 5.

The 5^{th} reservation may indicate that a 5^{th} electric car 705 is scheduled to be charged through the 2^{nd} charging point CP2 during T3 and T4.

During T4, a reservation 6 may be allocated to the 3^{rd} charging point CP3 to charge a 6^{th} electric car 706.

That is, the 3^{rd} charging point CP3 is allocated the reservation 3 from T1 to T3, and is allocated the reservation 6 during T4.

The processor 180 of the AI device 100 may schedule the charging reservations, such that six (6) reservations are made during T1 to T4 by using the three (3) charging points.

The processor 180 of the AI device 100 or the processor 260 of the AI server 200 may schedule charging reservations of the electric cars as described above.

As described above, according to an embodiment of the present disclosure, scheduling of electric cars can be efficiently performed with respect to the six (6) time interval relations through the three (3) charging points.

That is, the three (3) charging points are scheduled to occupy charging of the electric cars without an idle time, such that the charging points can be more efficiently used.

Hereinafter, a process of processing an exceptional situation in which a charging point is exclusively used when charging reservations of charging points are scheduled with respect to the thirteen (13) relations of the Allen's time interval algebra if the number of charging points is 10 will be described.

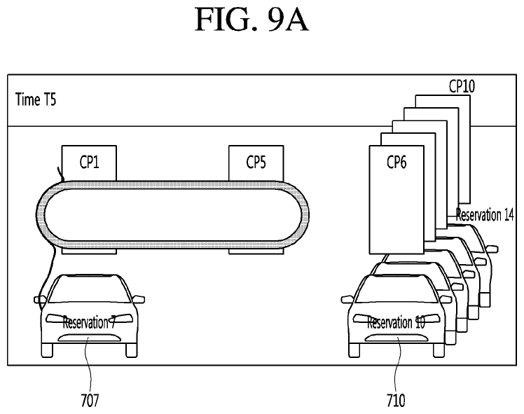

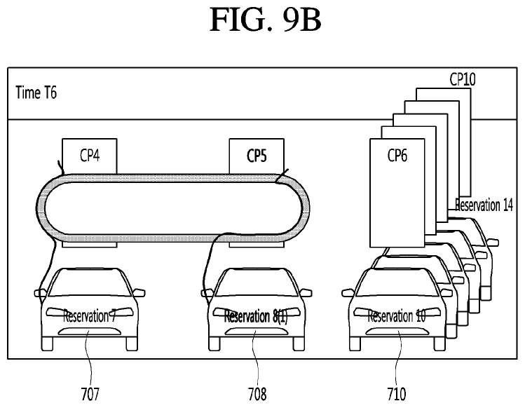

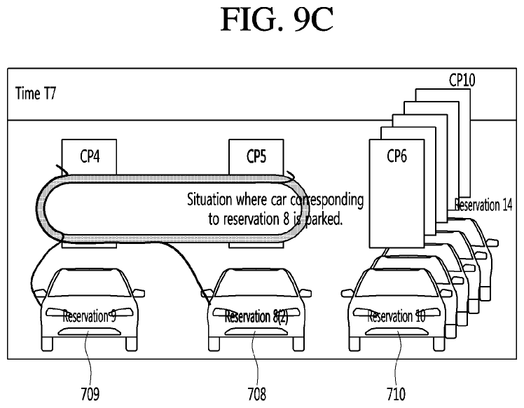

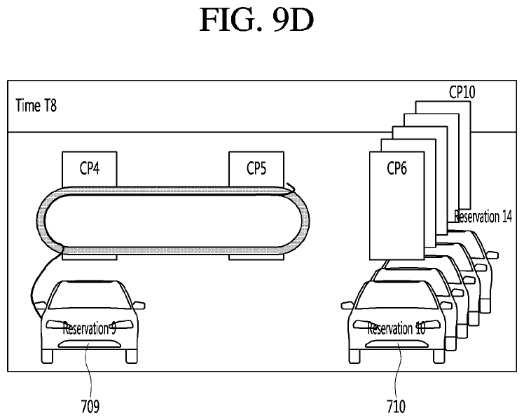

FIGS. 8 to 9D are views illustrating a process of scheduling charging reservations with respect to the thirteen (13) time interval relations through ten (10) charging points according to an embodiment of the present disclosure.

FIGS. 8 to 9D illustrate a process of scheduling charging reservations with respect to the other relations which are not dealt with in the embodiment of FIGS. 6 to 7D through seven (7) charging points.

The 7^{th} relation 507 to 13^{th} relation 513 may be divided into four (4) time periods T5, T6, T7, T8.

The 7^{th} relation 507 may be allocated to a 4^{th} charging point CP4, the 11^{th} relation 511 may be allocated to a 5^{th} charging point PC5, and the 8^{th} relation 508 may be allocated to a 6^{th} charging point CP6.

The 9^{th} relation 509 and the 10^{th} relation 510 may be allocated to a 7^{th} charging point CP7.

The 12^{th} relation 512 may be allocated to an 8^{th} charging point CP8.

The 13^{th} relation 513 may be allocated to a 9^{th} charging point CP9 and a 10^{th} charging point CP10.

The 7^{th} charging point CP7 may not process two reservations during the period of X since the period of Y overlaps during the period of X. That is, the 7^{th} charging point CP7 should exclusively process the charging reservation of the period of Y.

This indicates that the 7^{th} charging point CP7 should process only the reservation corresponding to the 10^{th} relation 510.

Accordingly, there is a need for using another charging point which is idle to deal with the reservation corresponding to the 9^{th} relation 509.

That is, some of the time periods corresponding to the 9^{th} relation 509 may be allocated to the 5^{th} charging point CP5, and the other period may be allocated to the 4^{th} charging point CP4.

This will be described in detail.

Referring to FIGS. 8 to 9D, a schedule to make the 4^{th} charging point CP4 charge a 7^{th} electric car 707 during T5 and T6 is referred to as a reservation 7.

A schedule to make the 6^{th} charging point CP6 charge a 10^{th} electric car 710 during T5 to T8 is referred to as a reservation 10.

A schedule to make the 7^{th} charging point CP7 charge an 11^{th} electric car during T5 to T8 is referred to as a reservation 11.

A schedule to make the 8^{th} charging point CP8 charge a 12^{th} electric car during T5 to T8 is referred to as a reservation 12.

A schedule to make the 9^{th} charging point CP9 charge a 13^{th} electric car during T5 to T8 is referred to as a reservation 13.

A schedule to make the 10^{th} charging point CP10 charge a 14^{th} electric car during T5 to T8 is referred to as a reservation 14.

According to the Allen's time interval algebra, charging points are not allocated to time period T6, T7 corresponding to the 9^{th} relation 509.

For this, the processor 180 may allocate the 5^{th} charging point CP5 which is idle to reserve charging during T6. That is, a schedule to make the 5^{th} charging point CP5 charge an 8^{th} electric car 708 during T6 is referred to as a reservation 8(1).

In addition, the processor 180 may allocate the 4^{th} charging point CP4 which is idle during T7. That is, a schedule to make the 4^{th} charging point CP4 charge the 8^{th} electric car 708 during T7 is referred to as a reservation 8(2).

The 8^{th} electric car 708 corresponding to the reservation 8 may be charged through two charging points during the charging period.

That is, the 8^{th} electric car 708 may be charged by using the 5^{th} charging point CP5 during T6, and may be charged by using the 4^{th} charging point CP4 during T7.

For this, the AI device 100 or the AI server 200 which manages charging schedules may include a switch to convert the charging points.

That is, the AI device 100 or the AI server 200 may supply power to the 8^{th} electric car 708 through the 5^{th} charging point CP5 during T6, and, at a start time of T7, may control the switch to convert the 5^{th} charging point CP5 into the 4^{th} charging point CP4.

Referring to FIGS. 9A and 9B, the 4^{th} charging point CP4 is scheduled to process the reservation 7 during T5 and T6.

The 5^{th} charging point CP5 is scheduled to process the reservation 8(1) during T6. Thereafter, when a start time of T7 arrives, the 4^{th} charging point CP4 may be scheduled to process the reservation 8(2) and the 5^{th} charging point CP5 may be scheduled to process a reservation 9 as shown in FIG. 9C.

That is, the 8^{th} electric car 708 which is scheduled to be charged according to the reservation 8(1) and the reservation 8(2) may be scheduled to be charged through the 5^{th} charging point CP5, and to have a power supply source converted into the 4^{th} charging point CP4.

The switch may be disposed between the 4^{th} charging point CP4 and the 5^{th} charging point CP5 to convert therebetween.

Thereafter, the 5^{th} charging point CP5 may be scheduled to continue processing the reservation 9 during T8 as shown in FIG. 9D.

As described above, according to an embodiment of the present disclosure, the idle time of each charging point is minimized and a charging occupancy time is increased, such that charging reservations can be efficiently scheduled.

In particular, according to an embodiment of the present disclosure, there is an advantage that an idle charging point which may be caused in the Allen's time interval algebra can be efficiently used.

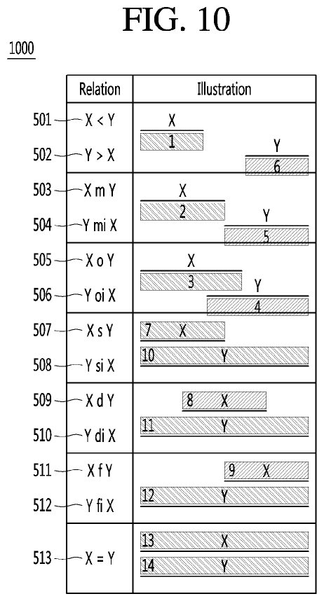

FIG. 10 is a view illustrating charging available time slots regarding the thirteen (13) time interval relations according to an embodiment of the present disclosure.

Referring to FIG. 10, a table 1000 which expresses the thirteen (13) relations as fourteen (14) charging available time slots by applying the time relation theory indicating that situations including time are defined by the thirteen (13) relations to charging scheduling of an electric car is illustrated.

Time slots corresponding to the respective relations are numbered from 1 to 14.

FIG. 11 is a view illustrating a process of setting a charging schedule by allocating the fourteen (14) time slots of FIG. 10 through ten (10) charging points according to an embodiment of the present disclosure.

FIG. 11 is a view illustrating one or more time slots allocated to charging points according to the charging scheduling of the electric cars of FIGS. 6 to 9D.

It is assumed that a model for scheduling charging reservations of the electric cars of FIGS. 6 to 9D is a charging reservation scheduling model.

The charging reservation scheduling model may be a model that allocates the fourteen (14) time slots indicated by the thirteen (13) time interval relations to a predetermined number of charging points.

That is, the charging reservation scheduling model may be a model that schedules charging reservations by allocating the fourteen (14) time slots to the predetermined number of charging points to minimize idle times of the predetermined number of charging points and to maximize a charging occupancy time.

The charging reservation scheduling model may be stored in the memory 170 of the AI device 100 or the AI server 200.

FIG. 11 shows a result of allocating the fourteen (14) time slots to charging points if there are ten (10) charging points. The result may be an output of the charging reservation scheduling model.

The charging reservation scheduling model may be a model that outputs a result of allocating time slots to charging points when the number of charging points is inputted.

FIG. 11 shows a result of allocating time slots to charging points on an hourly basis.

Each time slot may indicate a time interval during which charging is possible. Each time slot may be used for a user to make a charging reservation afterward.

Referring to FIG. 11, the 1^{st} charging point CP1 is allocated a 1^{st} time slot 1101 and a 4^{th} time slot 1104.

The 1^{st} time slot 1101 has an interval of 20 minutes, and the 4^{th} time slot 1104 may have an interval of 40 minutes.

The 2^{nd} charging point CP2 may be allocated a 2^{nd} time slot and a 5^{th} time slot 1105.

Each of the 2^{nd} time slot 1102 and the 5^{th} time slot 1105 may have an interval of 30 minutes.

The 3^{rd} charging point CP3 may be allocated a 3^{rd} time slot 1103 and a 6^{th} time slot 1106.

The 3^{rd} time slot 1103 may have an interval of 40 minutes, and the 6^{th} time slot 1106 may have an interval of 20 minutes.

The 4^{th} charging point CP4 may be allocated with a 7^{th} time slot 1107 and a part of an 8^{th} time slot 1108. The 7^{th} time slot 1107 may have an interval of 30 minutes, and the part of the 8^{th} time slot 1108 may have an interval of 10 minutes.

The 5^{th} charging point CP5 may be allocated a part of the 8^{th} time slot 1108 and a 9^{th} time slot 1109.

The 6^{th} charging point to 10^{th} charging points CP6 to CP10 may be allocated a 10^{th} time slot to a 14^{th} time slot 1110 to 1114, respectively.

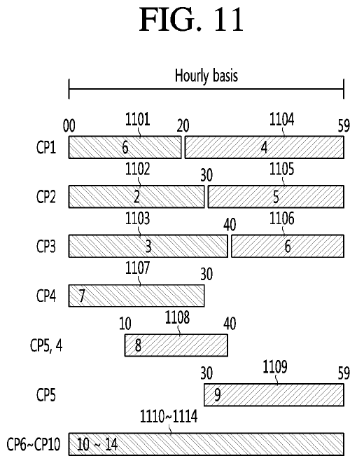

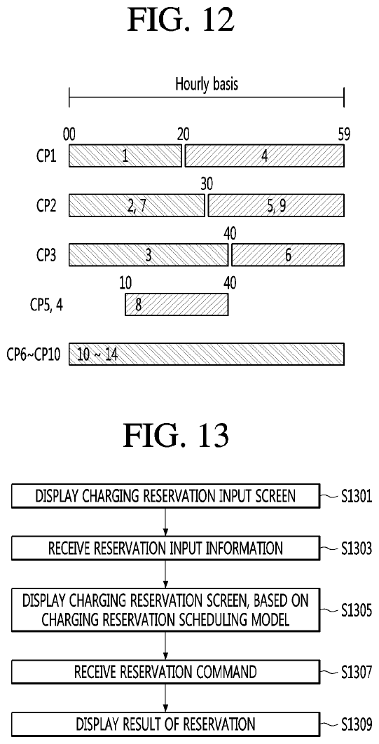

FIG. 12 is a view illustrating a summary of the result of allocating the fourteen (14) time slots to the charging points if there are 10 charging points.

That is, FIG. 12 illustrates the time slots of FIG. 11 more simply. That is, some time slots may overlap each other.

That is, the 2^{nd} charging point CP2, the 4^{th} charging point CP4, and the 5^{th} charging point CP5 may be allocated the time slots 1102, 1107, 1105, 1109 having the same time interval.

Thereafter, the summary of FIG. 12 may be provided to a user in the form of a UI, and the user may select a time slot and may proceed with a charging reservation of an electric car. This will be described hereinbelow.

FIG. 13 is a flowchart illustrating an operating method of an AI device according to an embodiment of the present disclosure.

In particular, FIG. 13 is a view illustrating a process of making a charging reservation of an electric car through the AI device.

Referring to FIG. 13, the processor 180 of the AI device 100 may display a charging reservation input screen through the display unit 151 (S1301).

In an embodiment, the charging reservation input screen may be a screen that is provided to make a charging reservation of an electric car. A charging reservation application may be installed in the AI device 100. The processor 180 may receive an execution command of the charging reservation application, and may display the charging reservation input screen on the display unit 151 according to the received execution command.

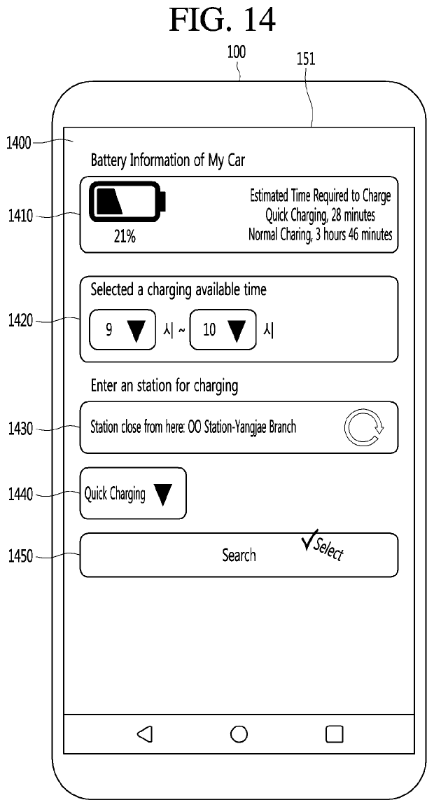

The charging reservation input screen will be described with reference to FIG. 14.

FIG. 14 illustrates an example of the charging reservation input screen according to an embodiment of the present disclosure.

A mobile terminal of a user will be described as an example of the AI device 100.

The display unit 151 of the AI device 100 may display a charging reservation input screen 1400 on the display unit 151.

The charging reservation input screen 1400 may be a UI screen through which the user inputs information necessary for a charging reservation of an electric car.

The charging reservation input screen 1400 may include a battery state information item 1410 of the electric car owned by the user, a charging available time setting item 1420, a charging oil station item 1430, a charging type setting item 1440, and a search button 1450.

The battery state information item 1410 of the electric car may be an item indicating a state of a battery provided in the user's electric car.

The battery state information item 1410 may include a charging capacity of the battery, an estimated time required to perform quick charging, and an estimated time required to perform normal (or slow) charging.

The AI device 100 may wirelessly communicate with the electric car through the communication interface 110, and may receive battery state information from the electric car.

The charging available time setting item 1420 may be an item for setting a charging time that is desired by the user. The user may select a desired time for charging the electric car through the charging available time setting item 1420.

The charging oil station item 1430 may be an item for setting an oil station for charging the electric car. The charging oil station item 1430 may provide a closest oil station as default with reference to a current location of the AI device 100.

The charging type setting item 1440 may be an item for setting any one of a quick charging type for charging the electric car at high speed, or a slow charging type for charging the electric car at normal speed.

The search button 1450 may be a button for searching a charging available time set through the charging available time setting item 1420 in the oil station set through the charging oil station item 1430.

FIG. 13 will be referred back to.

The processor 180 receives charging reservation input information (S1303), and may display a charging reservation screen including charging reservation information on the display unit 151, based on a charging reservation scheduling model, according to the received charging reservation input information (S1305).

The charging reservation input information may include a charging available time inputted through the charging available time setting item 1420, an oil station set through the charging oil station item 1430, and a charging type, as shown in FIG. 14.

The processor 180 may obtain charging reservation information in response to the charging reservation input information being received, and may display the charging reservation screen including the obtained charging reservation information on the display unit 151.

The processor 180 may obtain the charging reservation information based on the charging reservation input information and the charging reservation scheduling model.

The charging reservation information may include one or more oil stations where charging of the electric car is possible, and a charging available time table provided by the one or more oil stations.

The charging reservation scheduling model may be a model that allocates the fourteen (14) time slots indicated by the thirteen (13) time interval relations to a predetermined number of charging points, as described in FIGS. 5 to 9D.

The charging available time table may be a time table indicating whether the fourteen (14) time slots are available.

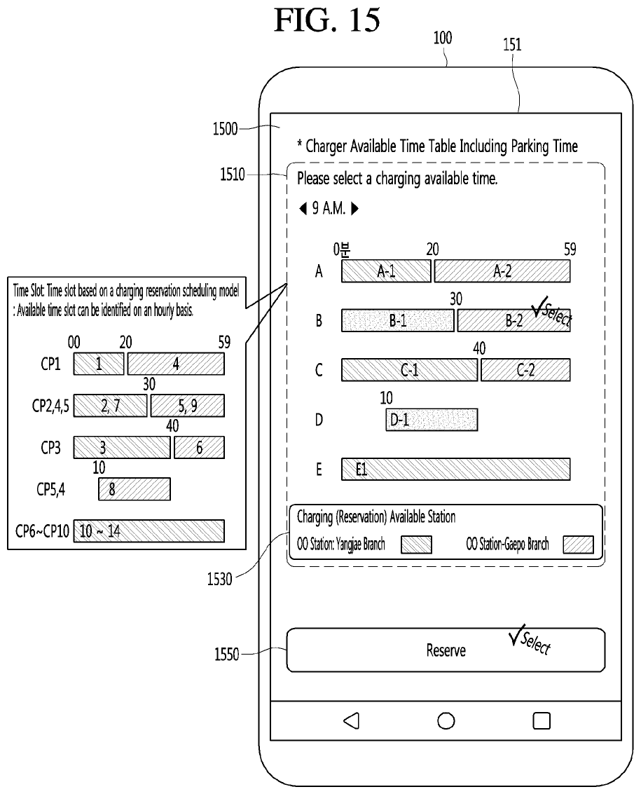

This will be described with reference to FIG. 15.

FIG. 15 is a view illustrating a charging reservation screen for providing charging reservation information according to an embodiment of the present disclosure.

Referring to FIG. 15, the charging reservation screen 1500 may include an available time table 1510 of a charger for charging the electric car, a charging available oil station item 1530, and a reservation button 1550.

The available time table 1510 of the charger may be a table which is generated by the charging reservation scheduling model, and in which one or more time slots match a plurality of charging points.

The charging available oil station item 1530 may include an oil station which is inputted through the charging oil station item 1430, and another oil station which is the closest to the inputted oil station.

The reason why a charging point of another oil station is considered is that the number of charging points provided in the oil station set by the user is not 10.

Since the charging reservation scheduling model allocates one or more time slots to the charging points on the assumption that there are ten (10) charging points, the processor 180 may search charging points provided in another oil station and may obtain ten (10) charging points if the oil station set by the user does not have ten (10) charging points.

The processor 180 may allocate one or more of the fourteen (14) time slots to the ten (10) charging points CP1 to CP10, and may display a result of allocating.

That is, the available time table 1510 of the charger shows one or more time slots allocated to the ten (10) charging points provided in two oil stations.

Each of the time slots A-1, C-1, E1 of a 1^{st} pattern indicates a charging available time at charging points provided in a 1^{st} oil station. The 1^{st} oil station may be an oil station that is set by the user through charging reservation input.

The time slots A-2, B-2, C-2 of a 2^{nd} pattern may indicate a charging available time at a charging point provided in a 2^{nd} oil station.

Each of the time slots B-1, D-1 of a 3^{rd} pattern may indicate that charging is impossible.

The processor 180 may generate the available time table 1510 of the charger by using the charging available time included in the charging reservation input information and the charging reservation scheduling model.

The processor 180 may generate the available time table 1510 of the charger by using the charging available time included in the charging reservation input information, the charging reservation scheduling model, and information regarding a charging point received from the one or more oil stations.

The processor 180 may receive the information regarding the charging point from the one or more oil stations through the communication interface 110. The information regarding the charging point may include an identifier of the charging point (or identifier of the oil station), and information on whether charging is possible at the charging point at the charging available time included in the charging reservation input information.

The processor 180 may allocate one or more of the fourteen (14) time slots to the ten (10) charging points by using the charging available time and the charging reservation scheduling model.

Thereafter, the processor 180 may determine a source of each time slot (oil station), and determine whether charging is possible in each time slot, by using the information regarding the charging point received from the one or more oil station.

The processor 180 may reflect a result of determining on the charger available time table 1510.

The processor 180 may receive a reservation command (S1307), and may display a result of reservation on the display unit 151 in response to the received reservation command (S1309).

When the time slot B-2 shown in FIG. 15 is selected and then a reservation command to select the reservation button 1550 is received, the processor 180 may display a result of charging reservation of the electric car on the display unit 151.

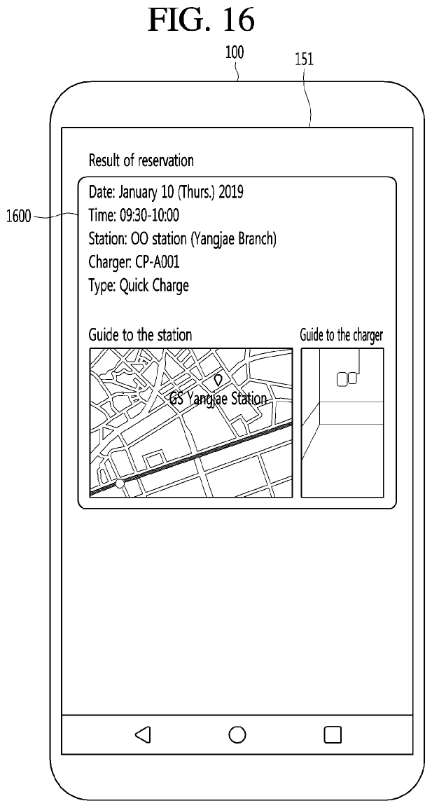

FIG. 16 is a view illustrating a result of charging reservation of an electric car according to an embodiment of the present disclosure.

Referring to FIG. 16, the display unit 151 of the AI device 100 may display a result of charging reservation 1600.

The result of charging reservation 1600 may include one or more of a charging reservation date, a reservation number, a charging reservation time, a name of an oil station, a name of a charger, a charging type, a map indicating a location of the oil station, and an image of the charger.

As described above, according to an embodiment of the present disclosure, a user can schedule a charging reservation of an electric car simply by a user input. Accordingly, a user's charging reservation process can be simplified and convenience can be greatly enhanced.

In addition, idle times of charging points provided in each oil station can be minimized and using efficiency of the charging points can be maximized.

The present disclosure may also be embodied as computer readable codes on a medium having a program recorded thereon. The computer readable medium is any data storage device that may store data which may be thereafter read by a computer system. Examples of the computer readable medium include HDD (Hard Disk Drive), SSD (Solid State Disk), SDD (Silicon Disk Drive), ROM, RAM, CD-ROM, a magnetic tape, a floppy disk, an optical data storage device, or the like. In addition, the computer may include the processor 180 of the AI device.

What is claimed is:

1. An AI device comprising:
a display; and
at least one processor configured to:
receive reservation input information for reserving charging of an electric car, and
cause, on the display, a display illustrating a charger available time table indicating an available time or an unavailable time of each of a plurality of chargers based on the received reservation input information and a charging reservation scheduling model, wherein the charger available time table comprises one or more time slots associated with each of the plurality of chargers.

2. The AI device of claim 1, wherein the charging reservation scheduling model is configured to allocate each of a plurality of chargers to one or more of a plurality of time slots indicating a plurality of time interval relations according to Allen's Time Interval Algebra.

3. The AI device of claim 2, wherein the charging reservation schedule model is further configured to allocate an idle charger to one or more of the plurality of time slots to minimize idle times of the plurality of chargers.

4. The AI device of claim 1, wherein each time slot included in the charger available time table indicates a source of a charger and information on whether charging is possible at an inputted charging time.

5. The AI device of claim 4, wherein each of the plurality of chargers is provided in one or more gas stations and a number of the plurality of chargers is 10.

6. The AI device of claim 1, wherein the at least one processor is further configured to receive a command to select the time slot and to cause a display of a result of charging reservation on the display in response to the received command.

7. The AI device of claim 6, wherein the result of the charging reservation comprises one or more of a charging reservation date, a reservation number, a charging reservation time, a name of a gas station, a name of a charger, a charging type, a map indicating a location of the gas station, or an image of the charger.

8. The AI device of claim 1, further comprising a communication interface,
wherein the at least one processor is further configured to receive information regarding a charger from one or more gas stations through the communication interface,
wherein the information regarding the charger comprises at least one of an identifier of a charging point, an identifier of a gas station, or information indicating whether charging of a charging point is possible at a charging available time included in the reservation input information.

9. The AI device of claim 8, wherein the at least one processor is further configured to:
determine a source of each time slot,
determine whether charging is possible at each time slot by using the information regarding the charger, and
generate the charger available time table according to a result of the determination of whether charging is possible at each time slot.

10. The AI device of claim 1, wherein the reservation input information further comprises a charging available time item for setting a charging time or a charging gas station item for setting a charging gas station.

11. An operating method of an AI device, the method comprising:
receiving reservation input information for reserving charging of an electric car; and
displaying a charger available time table indicating an available time or an unavailable time of each of a plurality of chargers based on the received reservation input information and a charging reservation scheduling model, wherein the charger available time table comprises one or more time slots are associated with each of the plurality of chargers.

12. The method of claim 11, wherein the charging reservation scheduling model is configured to allocate each of a plurality of chargers to one or more of a plurality of time slots indicating a plurality of time interval relations according to Allen's Time Interval Algebra.

13. The method of claim 12, wherein the charging reservation scheduling model is further configured to allocate an idle charger to one or more of the plurality of time slots to minimize idle times of the plurality of chargers.

14. The method of claim 11, wherein each time slot included in the charger available time table indicates a source of a charger and information on whether charging is possible at an inputted charging time inputted.

15. The method of claim 14, wherein each of the plurality of chargers is provided in one or more gas stations and a number of the plurality of chargers is 10.

16. The method of claim 11, further comprising:
receiving a command to select the time slot; and
displaying a result of charging reservation in response to the received command.

17. The method of claim 16, wherein the result of the charging reservation comprises one or more of a charging reservation date, a reservation number, a charging reservation time, a name of an gas station, a name of a charger, a charging type, a map indicating a location of the gas station, and an image of the charger.

18. The method of claim 11, further comprising receiving information regarding a charger from one or more gas stations,
wherein the information regarding the charger comprises at least one of an identifier of a charging point, an identifier of the gas station, or information indicating whether charging of a charging point is possible at a charging available time included in the reservation input information.

19. The method of claim 18, further comprising:
determining a source of each time slot;
determining whether charging is possible at each time slot by using the information regarding the charger; and
generating the charger available time table according to a result of the determination of whether charging is possible at each time slot.

20. The method of claim 11, wherein the reservation input information comprises a charging available time item for setting a charging time or a charging gas station item for setting a charging gas station.
